(19) United States
(12) Patent Application Publication
(10) Pub. No.: US 2010/0037837 A1
(43) Pub. Date: Feb. 18, 2010

(54) SOUNDPROOF TYPE ENGINE GENERATOR

(75) Inventors: Masato Yamasaki, Hiroshima-City (JP); Teruaki Matsubata, Hiroshima-City (JP); Hiroki Awata, Nagoya-City (JP)

Correspondence Address: MORRISON & FOERSTER LLP, 1650 TYSONS BOULEVARD, SUITE 400, MCLEAN, VA, 22102, US

(73) Assignee: MITSUBISHI HEAVY INDUSTRIES, LTD, Tokyo (JP)

(21) Appl. No.: 12/441,307

(22) PCT Filed: Sep. 14, 2006
(86) PCT No.: PCT/JP2006/318682

§ 371 Date: Mar. 13, 2009

(51) Int. Cl. F02F 1/34; F01P 7/04; F02M 35/02; F02B 77/13

(52) U.S. Cl. 123/41.6; 123/41.66; 123/198 E; 181/204

(57) ABSTRACT

A small and lightweight sound-proof generator exhibiting sufficient cooling effect. An inverter (19), an engine fan (32), a power generating body (33), an engine (34), a recoil fan (61), a recoil starter (63) are coaxially arranged sequentially from a first inlet port side. A first cooling air passage for cooling inverter (19), the power generating body (33), and the engine (34) with cooling air sucked by the engine fan (32) from the inlet port (21), and second and third cooling air passage for cooling a space surrounded by an inverter containing box (20), an engine fan cover (31), an engine cover (36) and a muffler cover (52) and a soundproof case with cooling air sucked by the recoil fan (61) from inlet ports (21b1) and (21b2) are formed. Cooling air passed through the first cooling air passage and cooling air passed through the second and the third cooling air passages are merged and discharged from an outlet port after cooling a muffler.

### REFERENCE TO RELATED APPLICATIONS

This application is a national stage application under 35 USC 371 of International Application No. PCT/JP2006/318682, filed Sep. 14, 2006, the contents of which are incorporated herein by reference.

### FIELD OF THE INVENTION

The present invention relates to a compact and lightweight soundproof type engine generator which is covered with a soundproof case.

### BACKGROUND OF THE INVENTION

An engine generator, which is an integrated system of a compact engine and an alternator driven by this engine, is highly portable, and thus suitable for use in urban areas. When intended to be used in an urban area, especially at night, this engine generator has to have a structure in which the entire system is covered with a soundproof case so as to suppress driving noise thereof as far as possible in consideration of an ambient environment. To further suppress leakage of the driving noise, it is necessary to reduce an opening area of the soundproof case as far as possible. At the same time, since an air cooled engine using no cooling water is employed in such an engine generator, securing cooling air to be supplied into the soundproof case is more critical.

However, reduction of the opening area of the soundproof case causes decrease in an intake and a discharge of cooling air supplied into the soundproof case, whereby the engine overheats to be disabled to operate. Conversely, increasing the opening area deteriorates a soundproofing effect. On the other hand, downsizing the soundproof case makes an air passage therein narrower, so that the air passage is deteriorated in ventilation performance, and thus is not expected to exert a sufficient cooling effect. For these reasons, it is inevitable to confront the reality that convenience in portability, reduction in weight, and reduction in size, which are required of a soundproof type generator, are difficult to achieve.

The invention disclosed in Japanese Patent Application Publication No. Hei 11-200861 relates to a generator obtained by housing an engine and a alternator in a soundproof case provided with an air inlet for intake of external air. A recoil starter, an engine fan, the alternator, the engine and a muffler, which are arranged in that order, are enclosed with a cylindrical cover, and cooling air is discharged from the air outlet provided to the soundproof case. The air inlet is provided to a side face of the soundproof case, the side face corresponding to a side face of an inverter unit.

However, in the invention disclosed in Japanese Patent Application Publication No. Hei 11-200861, the recoil starter is arranged in front of the engine fan, which serves as an obstacle against air intake to prevent effective cooling of the alternator and the engine.

Additionally, the invention employs a structure in which the inverter unit and a fuel tank are provided outside the cylindrical cover, and external air coming in from an air inlet passes along the side face of the inverter unit, then is sucked by the engine fan, and passes through the cylindrical cover. For this reason, cooling of the inverter unit and the fuel tank tends to be insufficient in this structure.

Furthermore, the cylindrical cover, which covers the engine fan, the alternator, the engine and the muffler, has the recoil starter fixed thereto. Accordingly, a reaction force of starting torque is acted on the cylindrical cover, and thus strength and rigidity are required of the cylindrical cover, which eliminates any choice but to form the cylindrical cover with a pressed sheet metal part, an aluminum cast or the like. This leads to a heavier weight of the engine generator, and makes weight reduction thereof difficult.

### SUMMARY OF THE INVENTION

The present invention is a soundproof type engine generator in which an inverter, an engine fan, a alternator, an engine, a recoil fan, and a recoil starter are coaxially arranged in that order from nearest to farthest from a first air inlet. The present invention is characterized in that: a first cooling air passage is formed to allow cooling air sucked by the engine fan from the first air inlet to cool the inverter, the alternator and the engine, second and third cooling air passages are formed to allow cooling air sucked by the recoil fan from second and third air inlets to cool a space surrounded by an inverter housing box, an engine fan cover and a muffler cover, and a soundproof case, and the cooling air having passed through the first cooling air passage and the second and third cooling air passage further cools a muffler, and is then discharged from an air outlet.

Additionally, the present invention is characterized in that: the second cooling air passage allows cooling air sucked by the recoil fan from the second air inlet to cool a front-face side of a fuel tank, and a back face of an operation panel, the third cooling air passage allows cooling air sucked by the recoil fan from the third air inlet to cool a back-face side of a fuel tank, a carburetor of the engine and a throttle driving motor fixed to an upper part of the carburetor.

Furthermore, the present invention is characterized in that the muffler is arranged over the recoil starter.

Furthermore, the present invention is characterized in that the inverter housing box, the engine fan cover and the engine cover are coupled to the engine fan cover, the engine cover and an air discharging duct with sealing members interposed therebetween, respectively.

Furthermore, the present invention is characterized in that the engine fan cover and the engine cover are fixed to the engine with sealing members interposed therebetween.

Furthermore, the present invention is characterized in that the engine fan cover is made of a resin.

Furthermore, the present invention is characterized in that a front-face cover of and a back-face cover of the soundproof case, and the engine cover are, made of a resin.

### BRIEF DESCRIPTION OF THE DRAWINGS

FIG. 1 is a perspective view showing an external appearance of a soundproof type engine generator according to the present invention;

FIG. 2 is a cross-sectional view showing an internal structure of the soundproof type engine generator according to the present invention;

FIG. 3 is an exploded view showing cooling air passages of the soundproof type engine generator according to the present invention;

FIG. 4 is an exploded view showing a first cooling air passage of the soundproof type engine generator according to the present invention;

FIG. 5 is a cross-sectional view showing a cooling air passage, which starts from a second air inlet, forming a second cooling air passage of the soundproof type engine generator according to the present invention;

FIG. 6 is a cross-sectional view showing a cooling air passage, which starts from a third air inlet, forming a third cooling air passage of the soundproof type engine generator according to the present invention.

### DETAILED DESCRIPTION OF THE INVENTION

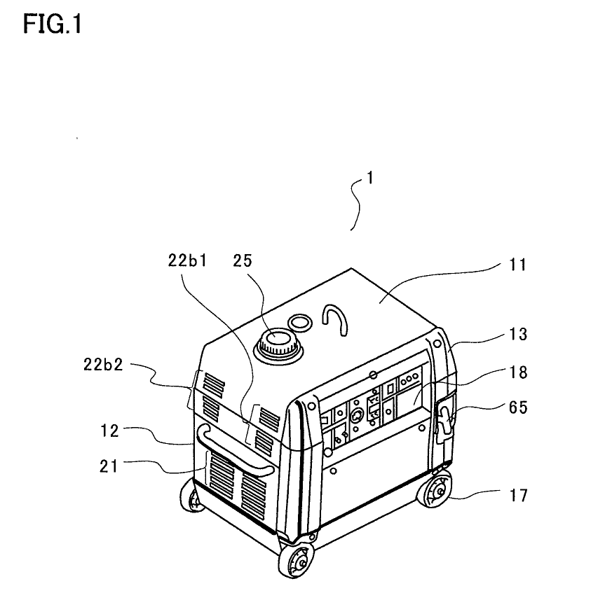

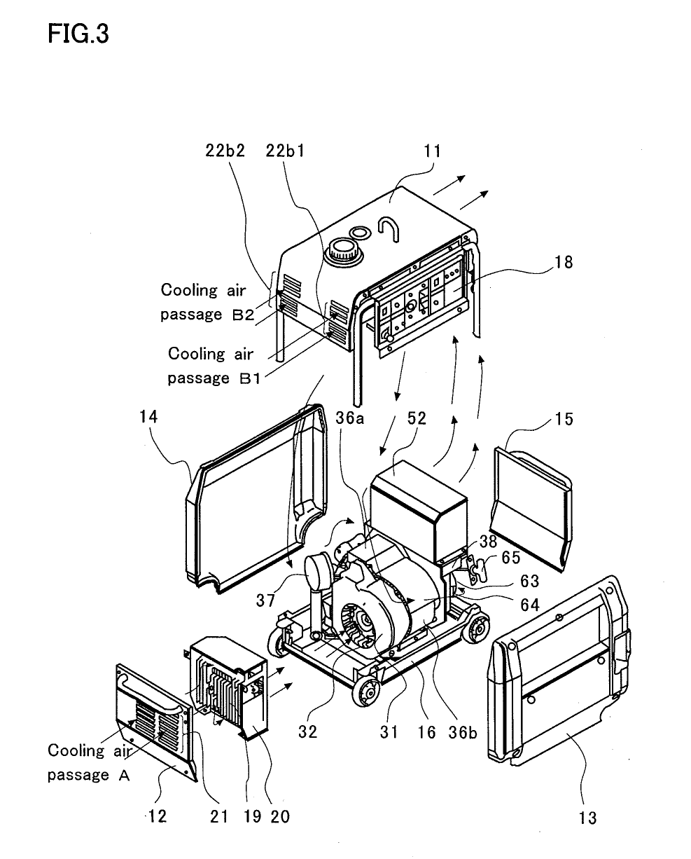

Description will be given of a perspective view, shown in FIG. 1, of a soundproof type engine generator 1 according to the present invention. Although an engine, a alternator and the like are covered by a soundproof case and cannot be seen, this configuration enhances a soundproof effect. The soundproof case is composed of a main frame 11, a left-side face cover 12, a front-face cover 13, a right-side face cover 15 (refer to FIG. 3) and a back-face cover 14 (refer to FIG. 3), the right-side face cover 15 and the back-face cover 14 existing behind the view.

In the left-hand side of the main frame 11, an air inlet 22b1 and an air inlet 22b2 are provided which form a second cooling air passage and a third cooling air passage, respectively. In an upper part of the main frame, there is a fuel tank cap 25, from which fuel is fed.

In the left-side face cover 12, a first air inlet 21 which forms a first cooling air passage is provided.

Through an opening of the front-face cover 13, there appear: a control panel 18 installed in the mainframe 11; and a recoil starter handle 65 by which the soundproof type engine generator 1 is started up.

The front-face cover 13 and the back-face cover 14 are both made of resin, whereby weight reduction is intended.

Wheels 17 are provided to four corners of a lower part of the soundproof type engine generator 1, whereby the soundproof type engine generator 1 can be effortlessly moved.

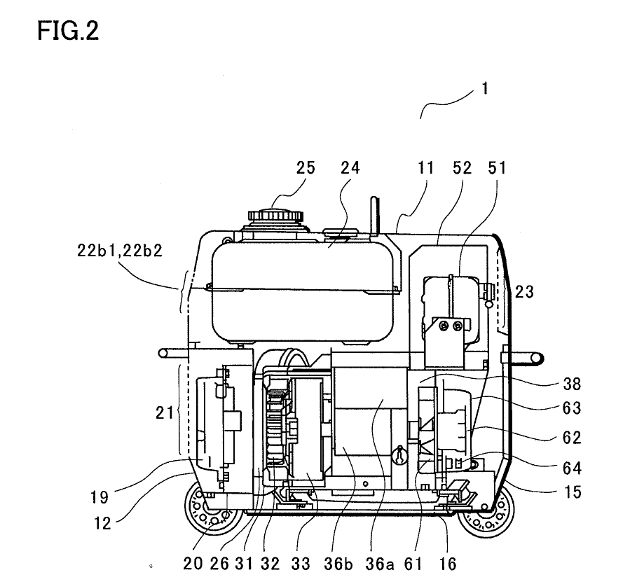

Next, with reference to FIG. 2, description will be given of a schematic structure of the soundproof type engine generator 1 according to the present invention. FIG. 2 is a cross-sectional view showing an internal structure of the soundproof type engine generator 1 according to the present invention.

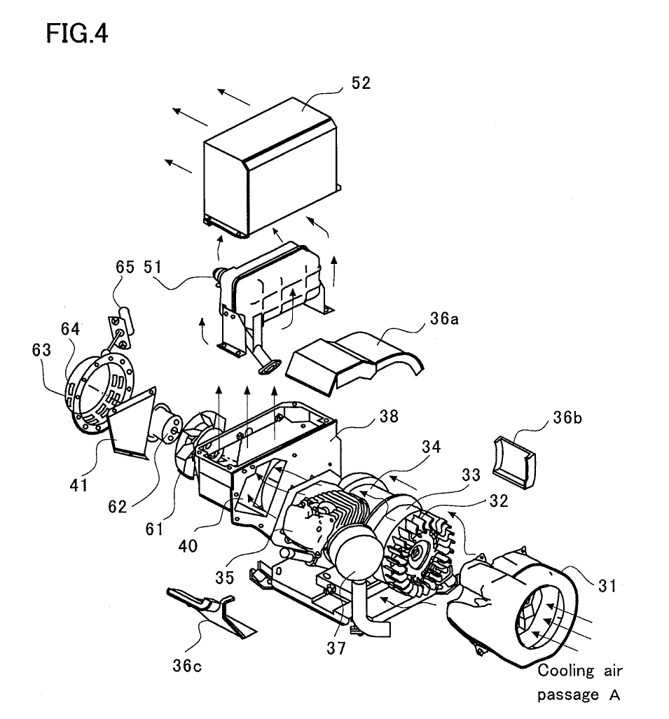

On a base 16 in the lower part of the soundproof type engine generator 1, there are coaxially arranged in the following order from nearest to furthest from the first air inlet 21: an inverter 19; an engine fan 32; a alternator 33; an engine 34 (refer to FIG. 4) covered by engine covers 36a, 36b and 36c (refer to FIG. 4); a recoil fan 61 covered by an air discharging duct 38; and a recoil starter 63. Shafts of the engine fan 32, of a rotor of the alternator 33, of the engine 34, of the recoil fan 61, and of a starter pulley 62 which is a constituent of the recoil starter 63 are coupled to one another.

The inverter 19 is installed inside an inverter housing box 20. There is the air inlet 21 in front of the inverter 19, and the inverter 19 is cooled directly by cooling air thereof. Here, this inverter 19 converts, into a direct-current voltage, an alternating-current voltage generated by the alternator 33.

The engine fan 32 and the alternator 33 are installed in an engine fan cover 31 located in back of the inverter housing box 20. The engine fan 32 is coupled to the rotor of the alternator 33 located in back thereof. The rotor of the alternator 33 has a shaft at the center thereof, thereby being coupled to a crankshaft of the engine 34. The engine fan 32 rotates with the engine 34 being driven, and sucks cooling air from the first air inlet 21. Likewise, the rotor of the alternator 33 rotates with the engine 34 being driven, and generates an alternating-current voltage.

Since the recoil starter 63 is arranged in back of the engine 34, the engine fan cover 31 is not subjected to a reaction force of starting torque. Consequently, the fan cover 31 does not require strength and rigidity, and is therefore made of resin. By having the fan cover 31 made of resin, weight reduction of the soundproof type engine generator 1 is achieved.

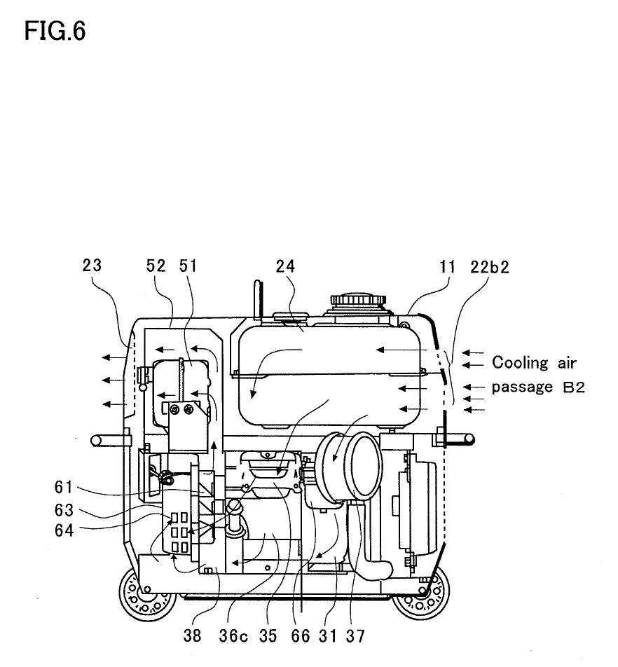

The engine 34 is covered by the engine covers 36a, 36b and 36c. These engine covers 36a, 36b and 36c form a cooling passage, and, at the same time, is effective in suppressing driving noise. Here, fuel fed from a fuel tank 24 via a carburetor 66 (refer to FIG. 6) is burnt, thereby causing the crankshaft of the engine 34 to rotate, and causing the engine fan 32 and the rotor of the alternator 33 to rotate. Additionally, the crankshaft of the engine 34 is coupled also to the recoil fan 61 and the starter pulley 62 being a constituent of the recoil starter 63, which are located in back of the engine 34, and thereby causes the recoil fan 61 to rotate.

As will be described later, since the inside of the soundproof case can be efficiently cooled by the second and third cooling air passages, the front-face cover 13 (refer to FIG. 3) and the back-face cover 14 (refer to FIG. 3) of the soundproof case, and the engine covers 36a, 36b and 36c are made of resin, whereby weight reduction of the soundproof type engine generator 1 is achieved.

A front part of the engine fan cover 31 covering the engine fan 32 and the alternator 33, and a rear part of the inverter housing box 20 are connected to each other with a sealing member 26 interposed therebetween, which restrains air inside the soundproof case from being sucked through an interstice between the engine fan cover 31 and the inverter housing box 20.

Additionally, a rear part of the engine fan cover 31 is connected to each of the engine covers 36a, 36b and 36c covering the engine 34, and a sealing member is interposed therebetween, which restrains air from leaking into the soundproof case, the air having cooled the inverter 19 and the alternator 33.

A rear part of each of the engine covers 36a, 36b and 36c is connected to the air discharging duct 38 with a sealing member (an illustration of which is omitted) interposed therebetween, whereby air having cooled the engine 34 is guided to the air discharging duct 38 without leaking into the soundproof case.

The recoil fan 61 is located in back of the engine 34, and in front of the recoil starter 63, and is arranged inside the air discharging duct 38. The recoil fan 61 coupled to the crankshaft of the engine 34 rotates with the engine 34 being driven. With the rotation of the recoil fan 61, cooling air sucked in from the second air inlet 22b1 and the third air inlet 22b2 is sucked into the inside of the air discharging duct 38 through recoil air inlets 64 provided in the recoil starter 63.

The starter pulley 62 which is a constituent of the recoil starter 63 is arranged in back of the recoil fan 61, and is coupled to the crankshaft of the engine 34. The recoil starter 63 has a reel (an illustration of which is omitted) housed in the inside thereof, and a cord (an illustration of which is omitted) wound around the reel and the recoil starter handle 65 (refer to FIG. 3) are connected to each other. By pulling out the cord by use of the recoil starter handle 65, the reel is coupled to the starter pulley 62, the crankshaft of the engine 34 is caused to rotate, and the engine 34 is started up. After the cord is pulled out, the cord is stored inside the recoil starter 63 by means of a reel winding-back mechanism such as a spring. The coupling between the starter pulley 62 and the reel is cut off after the startup of the engine.

A muffler 51 is covered by a muffler cover 52, and is arranged over the recoil starter 63. This muffler 51 is connected to the engine 34, and combustion gas generated with the engine 34 being driven passes through the muffler 51 and is discharged, along with cooling air, to the outside of the soundproof case through an air outlet 23.

By having the muffler 51 arranged over the recoil starter 63, space inside the soundproof case can be effectively utilized, whereby downsizing of the soundproof type engine generator 1 is achieved. Furthermore, since the muffler 51 is arranged over the recoil fan 61 while the recoil fan 61 is housed inside the air discharging duct 38 connected to the engine 34 and the recoil starter 63, cooling air can be effectively collected, and efficiently cools the muffler 51.

The fuel tank 24 is installed in an upper left part of the inside of the soundproof case so as to be suspended from the main frame 11.

With reference to FIG. 3, description will be given of an overview of the cooling air passages according to the present invention. Here, the description will be given with: the first cooling air passage, through which cooling air sucked from the first air inlet 21 flows, being referred to as a cooling air passage A; the second cooling air passage, through which cooling air sucked from the second air inlet 22b1 flows, being referred to as a cooling air passage B1; and the third cooling air passage, through which cooling air sucked from the third air inlet 22b2 flows, being referred to as a cooling air passage B2.

First of all, description will be given of an overview of the cooling air passage A.

The engine 34 (refer to FIG. 4) is started up with the recoil starter handle 65 being pulled. The engine fan 32 rotates with the engine 34 being driven, and sucks cooling air from the first air inlet 21 provided in the left-side face cover 12, thereby cooling the inverter 19 housed in the inverter housing box 20. The cooling air runs into cooling fins on a front face of the inverter 19, and then, after cooling the inverter 19, is sucked into the engine fan cover 31 while flowing around upper and lower parts of the inverter 19. Since the rear part of the inverter housing box 20 and the front part of the engine fan cover 31 are tightly attached to each other with the sealing member 26 (refer to FIG. 2) interposed therebetween, air inside the soundproof case cannot be sucked into, but only external air having sucked from the air inlet 21 is sucked into the engine fan cover 31.

The cooling air cools the alternator 33 (refer to FIG. 4) inside the engine fan cover 31, and then, after being fed into the engine covers 36a, 36b and 36c, cools the engine 34. The air having cooled the engine 34 is fed into the air discharging duct 38. While the engine fan cover 31, and the engine covers 36a, 36b and 36c are fixed to the engine 34 with sealing members interposed therebetween, the engine fan cover 31 and the engine covers 36a, 36b and 36c are coupled to one another with the sealing members (an illustration of which is omitted) interposed therebetween. Thereby, the cooling air is prevented from being discharged into the soundproof case. However, in order to efficiently cool a throttle driving motor (an illustration of which is omitted) fixed to the carburetor 66 (refer to FIG. 6), the sealing member between the engine 34 and the engine fan cover 31 is partially removed in the neighborhoods of the carburetor 66, whereby air around the throttle driving motor is convected. Since each of the engine covers 36a, 36b and 36c and the air charging duct 38 are tightly attached to each other with a sealing member (an illustration of which is omitted) interposed therebetween, the cooling air is fed into the air discharging duct 38 without leaking into the soundproof case.

Next, description will be given of an overview of the cooling air passage B1 and the cooling air passage B2.

The recoil fan 61 (refer to FIG. 2) rotates, whereby cooling air is introduced into the soundproof case from the second air inlet 22b1 and the third air inlet 22b2 which are provided in the left-hand side of the main frame 11. After cooling a space surrounded by the inverter housing box 20, the engine fan cover 31, the engine covers 36a, 36b and 36c, the air discharging duct 38 and the muffler cover 52, and the soundproof case, the thus introduced cooling air is sucked into the recoil air inlet 64 provided in the recoil starter 63.

The cooling air passage B1 mainly cools the front-face side of the fuel tank 24 (refer to FIG. 2) and a back face of the operation panel 18.

Additionally, the cooling air passage B2 mainly cools the back-face side of the fuel tank 24, the carburetor 66 and the throttle driving motor.

The cooling air having passed through the respective cooling air passages join together in the engine air discharging duct 38, and then, after cooling the muffler 51 (refer to FIG. 2) housed inside the muffler cover 52, is discharged from the air outlet 23 (refer to FIG. 2) provided in the right-hand side of the main frame 11.

With reference to FIG. 4, detailed description will be given of the cooling air passage A according to the present invention.

When the engine 34 is started up with the recoil starter handle 65 being pulled, the engine fan 32 coupled to the crankshaft of the engine 34 rotates. As shown in FIG. 3, cooling air is sucked in from the first air inlet 21 (refer to FIG. 3) provided in the left-side face cover 12, and cools the inverter 19 (refer to FIG. 3) housed in the inverter housing box 20 (refer to FIG. 3). The air having cooled the inverter 19 is sucked into the engine fan cover 31. Since the inverter housing box 20 and the engine fan cover 31 are tightly attached to each other with a sealing member 31 (refer to FIG. 2) interposed therebetween, air inside the soundproof case cannot be sucked into, but only external air having sucked from the air inlet 21 is sucked into the engine fan cover 31.

The cooling air having been sucked into the engine fan cover 31 cools the alternator 33.

Thereafter, the cooling air cools the engine 34 located in back of the alternator 33. While the engine fan cover 31, and the engine covers 36a, 36b and 36c are fixed to the engine 34 with sealing members interposed therebetween, the engine fan cover 31 and the engine covers 36a, 36b and 36c are coupled to one another with the sealing members (an illustration of which is omitted) interposed therebetween. Thus, leakage of the cooling air is prevented. Consequently, the engine 34 is efficiently cooled by the cooling air having been sucked by the engine fan.

Note that, in order to efficiently cool the throttle driving motor (an illustration of which is omitted) fixed to the carburetor 66 (refer to FIG. 6), the sealing member between the engine 34 and the engine fan cover 31 is partially removed in the neighborhoods of the carburetor 66. Although, in this structure, effective cooling of the throttle driving motor is aimed by convecting air by thus removing the sealing members, another structure may be employed where, with sealing members being applied also to these sections, air suction is guided through the third air inlet 22b2 (refer to FIG. 3) by means of a duct or the like.

Additionally, since the engine fan 32 and the alternator 33 being noise sources are surrounded by the engine fan cover 31, and the engine 34 also being a noise source is surrounded by the engine covers 36a, 36b and 36, this structure is excellent in soundproofing effect. Furthermore, since these members are surrounded by the main frame 11, the front-face cover 18, the left-side face cover 12, the right-side face cover 15 and the back-face cover 14 (respectively refer to FIG. 3), a double-layered soundproofing structure is formed, and the soundproofing effect is enhanced thereby.

Each of the engine covers 36a, 36b and 36c that cover the engine 34 and the air discharging duct 38 are coupled to each other with the sealing member (an illustration of which is omitted) interposed therebetween, whereby the cooling air having cooled the engine 34 is fed into the air discharging duct 38 through a ventilation hole 40 without leaking into the soundproof case. This cooling air is mixed, in the engine air discharging duct 38, with the cooling air having passed through the cooling air passage B1 and the cooling air passage B2, and is then fed into the muffler cover 52. After cooling the muffler 51 housed in the muffler cover 52, the cooling air is discharged to the outside from the air outlet 23 (refer to FIG. 2) provided in the right-hand side of the main frame 11 (refer to FIG. 3).

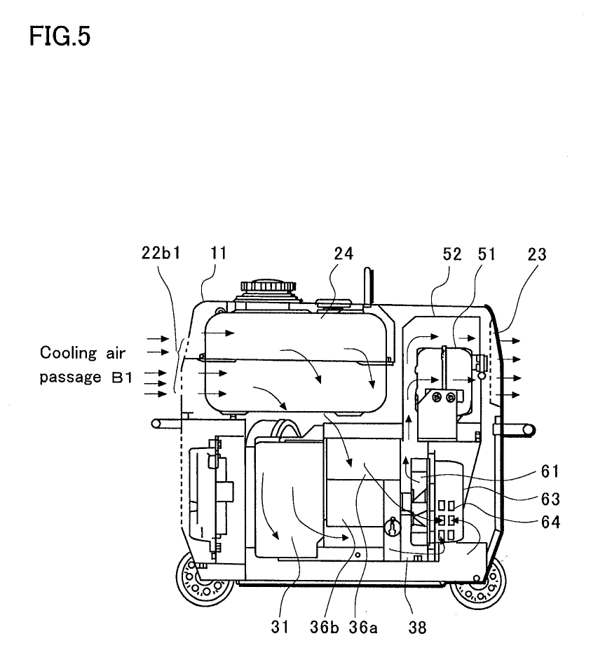

With reference to FIG. 5, detailed description will be given of the cooling air passage B1.

With the engine 34 (refer to FIG. 4) being driven, the recoil fan 61 (refer to FIG. 2) coupled to the crankshaft of the engine 34 rotates. When the recoil fan 61 rotates, external air is sucked into the soundproof case from the second air inlet 22b1 provided in a front-face side portion of the left-hand side of the main frame 11.

Cooling air having been sucked into the soundproof case cools, first of all, the front-face side of the fuel tank 24, and the back face of the operation panel 18 (refer to FIG. 3) provided in the front-face side of the main frame 11.

Then, after cooling surfaces of the engine fan cover 31, and the engine covers 36a and 36b, the cooling air is sucked by the recoil air inlet 64 provided in the recoil starter 63.

The cooling air having sucked by the recoil air inlet 64 is fed into the air discharging duct 38. Here, this cooling air is mixed, in the engine air discharging duct 38, with the cooling air having passed through the cooling air passage A and the cooling air passage B2, and is then fed into the muffler cover 52. After cooling the muffler 51, the cooling air is discharged to the outside from the air outlet 23 provided in the right-hand side of the main frame 11.

Although temperatures of electrical components of the operation panel 18, and a temperature of the fuel tank 24 rise to some extent because a temperature inside the soundproof case rises due to radiation heat emitted from a surface of the engine 34, and also due to the cooling air leaking from the neighborhood of the carburetor 66 and coming from the first cooling air passage, the electrical components and the fuel tank 24 are effectively cooled down by the cooling air passage B1, and are restrained from rising in temperature.

With reference to FIG. 6, detailed description will be given of the cooling air passage B2.

With the engine 34 (refer to FIG. 4) being driven, the recoil fan 61 (refer to FIG. 2) coupled to the crankshaft of the engine 34 rotates. When the recoil fan 61 rotates, external air is sucked into the soundproof case from the third air inlet 22b2 provided in the back-face side portion of the left-hand side of the main frame 11.

Cooling air having been sucked into the soundproof case cools, first of all, the back-face side of the fuel tank 24.

Then, the cooling air is partially sucked into an air cleaner 37, and, after cooling the carburetor 66, a cylinder head 35, the engine fan cover 31, and surfaces of the engine covers 36a (refer to FIG. 3) and 36c, the cooling air is sucked by the recoil air inlet 64.

The cooling air having been sucked by the recoil air inlet 64 is fed into the air discharging duct 38. Here, this cooling air is mixed, in the engine air discharging duct 38, with the cooling air having passed through the cooling air passage A and the cooling air passage B1, and is then fed into the muffler cover 52. After cooling the muffler 51 provided inside the muffler cover 52, the cooling air is discharged to the outside from the air outlet 23 provided in the right-hand side of the main frame 11.

Although temperatures of fuel inside the fuel tank 24 and inside the carburetor 66 rise to some extent because a temperature inside the soundproof case rises due to radiation heat emitted from the surface of the engine 34, and also due to the cooling air leaking from the neighborhood of the carburetor 66 and coming from the first cooling air passage, the fuel inside the fuel tank 24 and inside the carburetor 66 is effectively cooled down by the cooling air passage B2, and is restrained from rising in temperature.

According to the present invention, the recoil starter is arranged in back of the engine, whereby the first cooling air passage for the cooling air sucked by the engine fan is prevented from being blocked, and an efficient cooling effect is achieved with a large amount of cooling air being sucked from the outside.

Additionally, since an interstice between each adjacent ones of the inverter housing box, the engine fan cover, the engine cover, and the air discharging duct is tightly closed, cooling air sucked by the engine fan cannot leak from the covers, whereby the inverter, the alternator and the engine can be efficiently cooled in sequence.

Furthermore, a space surrounded by the inverter housing box, the engine fan cover, the engine covers and the muffler cover, and the soundproof case can be cooled by cooling air sucked by the recoil fan. Even the electrical components of the operation panel, the throttle driving motor of the carburetor, and the fuel inside the fuel tank and inside the carburetor, which rise in temperature due to radiation heat and the like, can be cooled, the radiation heat being emitted from the surface of the engine. Thereby, stable fuel supply is possible while heat-attributable breakdowns of the electrical components can be prevented.

Furthermore, by having the muffler arranged over the recoil starter and over the air discharging duct inside which the cooling air sucked by the engine fan and the recoil fan are mixed, downsizing of the engine generator is achieved through effective utilization of space inside the soundproof case while efficient cooling of the muffler is also possible.

Furthermore, by having the recoil starter arranged in back of the engine, the engine fan is not subject to the reaction force of starting torque and thereby does not require strength and rigidity. Therefore, the engine fan cover can be made of resin. Consequently, weight reduction is achieved.

Furthermore, since the inside of the soundproof case can be effectively cooled by having the second and third cooling air passages provided as described above, the front-face cover and back-face cover of the soundproof case, and the engine covers can be made of resin, which also leads to weight reduction of the generator.

1. A soundproof type engine generator comprising:
an inverter; an engine fan; an alternator; an engine; a recoil fan; a recoil starter; a first air inlet; a second air inlet; a third air inlet; an air outlet; a muffler; and a soundproof case,
wherein the inverter, the engine fan, the alternator, the engine, the recoil fan and the recoil starter are coaxially arranged in this order from the first air inlet to the air outlet,
upon energizing of the engine, a first cooling air passage is formed to allow cooling air sucked by the engine fan from the first air inlet to cool the inverter, the alternator and the engine,
upon energizing of the engine, second and third cooling air passages are formed to allow cooling air sucked by the recoil fan from the second and third air inlets, respectively, to cool a space surrounded by an inverter housing box, an engine fan cover, an engine cover and a muffler cover and the soundproof case, and
the cooling air having passed through the first cooling air passage and the second and third cooling air passages further cools the muffler and is discharged from the air outlet.

2. The soundproof type engine generator according to claim 1, wherein the second cooling air passage allows the cooling air sucked by the recoil fan from the second air inlet to cool a front-face side of a fuel tank and a back face of an operation panel, and the third cooling air passage allows the cooling air sucked by the recoil fan from the third air inlet to cool a back-face side of the fuel tank, a carburetor of the engine and a throttle driving motor fixed to an upper part of the carburetor.

3. The soundproof type engine generator according to claim 1, wherein the muffler is arranged over the recoil fan and the recoil starter.

4. The soundproof type engine generator according to claim 1, wherein the inverter housing box is connected to the engine fan cover with a sealing member, the engine fan cover is connected to the engine cover with a sealing member, and the engine cover is connected to an air discharging duct with an sealing member.

5. The soundproof type engine generator according to claim 1, wherein the engine fan cover and the engine cover are connected to the engine with sealing members.

6. The soundproof type engine generator according to claim 1, wherein the engine fan cover is made of a resin.

7. The soundproof type engine generator according to claim 1, wherein a front-face cover and a back-face cover of the soundproof case and the engine cover are made of a resin.
